(19) United States
(12) Patent Application Publication
(10) Pub. No.: US 2006/0011034 A1
(43) Pub. Date: Jan. 19, 2006

(54) Riving knife assembly for table saws

(76) Inventors: Robert S. Gehret, Hampstead, MD (US); Robert Kusmierski, Felton, PA (US); Mark D. Miller, Airville, PA (US)

Correspondence Address: THE BLACK & DECKER CORPORATION, 701 EAST JOPPA ROAD, TW199, TOWSON, MD, 21286, US

(21) Appl. No.: 11/178,900

(22) Filed: Jul. 11, 2005

Related U.S. Application Data
(60) Provisional application No. 60/587,622, filed on Jul. 13, 2004.

(51) Int. Cl. B25H 1/00

(52) U.S. Cl. 83/477.2; 83/522.17; 144/286.5

(57) ABSTRACT

A power tool having a base assembly, a table supported by the base assembly, a saw assembly supported by the table, and a riving knife assembly attached to the saw assembly. The riving knife has a body with an edge placed adjacent to a blade, and a bracket connected to the body. The bracket is inserted into a support assembly disposed on the saw assembly.

### REFERENCE TO CROSS-RELATED APPLICATION

The present application derives priority under 35 USC 119(e) from U.S. patent application Ser. No. 60/587,622, filed Jul. 13, 2004.

### FIELD OF THE INVENTION

This invention relates generally to a riving knife assembly for table saws and more specifically to a riving knife assembly for a combination table/miter saw.

### BACKGROUND OF THE INVENTION

It is well known in the table saw field to provide a riving knife assembly behind the table saw blade. Typically the riving knife assembly is difficult to remove from the table saw. Accordingly, it is an object of the invention to provide an enhanced riving knife assembly.

### SUMMARY OF THE INVENTION

In accordance with the present invention, an improved support assembly is employed. The power tool has a base assembly, a table supported by the base assembly, a saw assembly supported by the table, and a riving knife assembly attached to the saw assembly, the riving knife comprising a body having an edge placed adjacent to a blade, and a bracket connected to the body, wherein the bracket is inserted into a support assembly disposed on the saw assembly.

Additional features and benefits of the present invention are described, and will be apparent from, the accompanying drawings and the detailed description below.

### DESCRIPTION OF THE DRAWINGS

The accompanying drawings illustrate preferred embodiments of the invention according to the practical application of the principles thereof, and in which:

FIG. 1 illustrates a combination table/miter saw according to the invention, whereas FIGS. 1A-1B are side views of the combination table/miter saw in the miter saw and table saw modes, respectively;

FIG. 2 is a perspective view of a riving knife assembly according to the invention;

FIG. 3 is a partial perspective view along line III-III of FIG. 2;

FIG. 4 is a perspective view of the riving knife assembly stored in the combination table/miter saw;

FIG. 5 is a partial perspective view of a blade guard assembly installed unto the riving knife assembly; and

FIG. 6 is a partial cross-sectional view of the blade guard and riving knife assemblies along a center plane of the body of the riving knife assembly.

### DETAILED DESCRIPTION

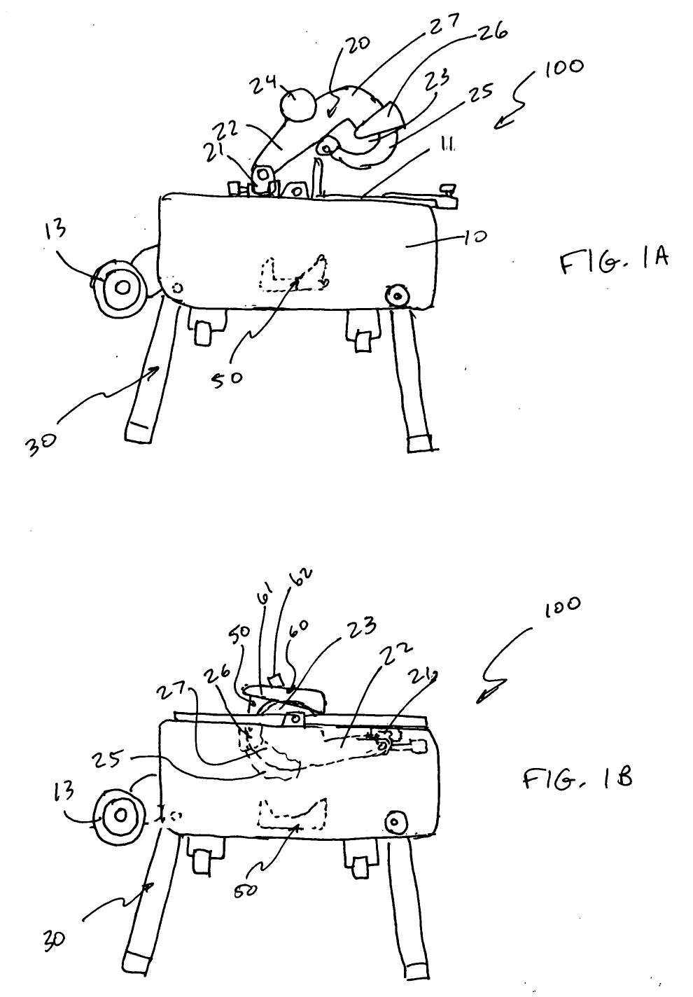

The invention is now described with reference to the accompanying figures, wherein like numerals designate like parts. Referring to FIG. 1, a combination table/miter saw 100 may include a base assembly 10, a table 11 supported by base assembly 10, and a saw assembly 20 supported by the table 11. Saw assembly 20 may include a trunnion 21 disposed on the table 11, a pivotable arm 22 pivotably attached to trunnion 21, a motor 24 supported by the arm 22 and driving a blade 23. Arm 22 also supports upper blade guard 27, which covers an upper part of blade 23. Lower blade guard 25 is pivotally attached to upper blade guard 27. An auxiliary blade guard 26 may be pivotably connected to lower blade guard 25.

Preferably, table 11 is pivotally attached to base assembly 10 via joint 15 so that, when the table 11 is in the orientation of FIG. 1A, the saw assembly 20 can act as a miter saw, i.e., saw assembly 20 can be pivoted downwardly towards table 11 to cut a workpiece placed on table 11.

On the other hand, when table 11 is rotated via joint 15 to the orientation of FIG. 1B, the saw 100 acts as a table saw, i.e., saw assembly 20 will be supported by and disposed underneath the table 11. In such orientation, blade 23 extends through the table 11, so that a user can dispose a workpiece on table 11 and push it towards blade 23 for cutting.

Persons skilled in the art will recognize that the invention described below can be applicable to non-combined table saws.

Preferably, base assembly 10 has at least one wheel 13 thereon.

Base assembly 10 may also support four leg assemblies 30. Preferably leg assemblies 30 are pivotally attached to base assembly 10.

Because the saw 100 can be used as either a table saw or a miter saw, it is preferable to provide a riving knife assembly 50 which can be easily installed when saw 100 is to be used as a table saw and easily removed when saw 100 is to be used as a miter saw.

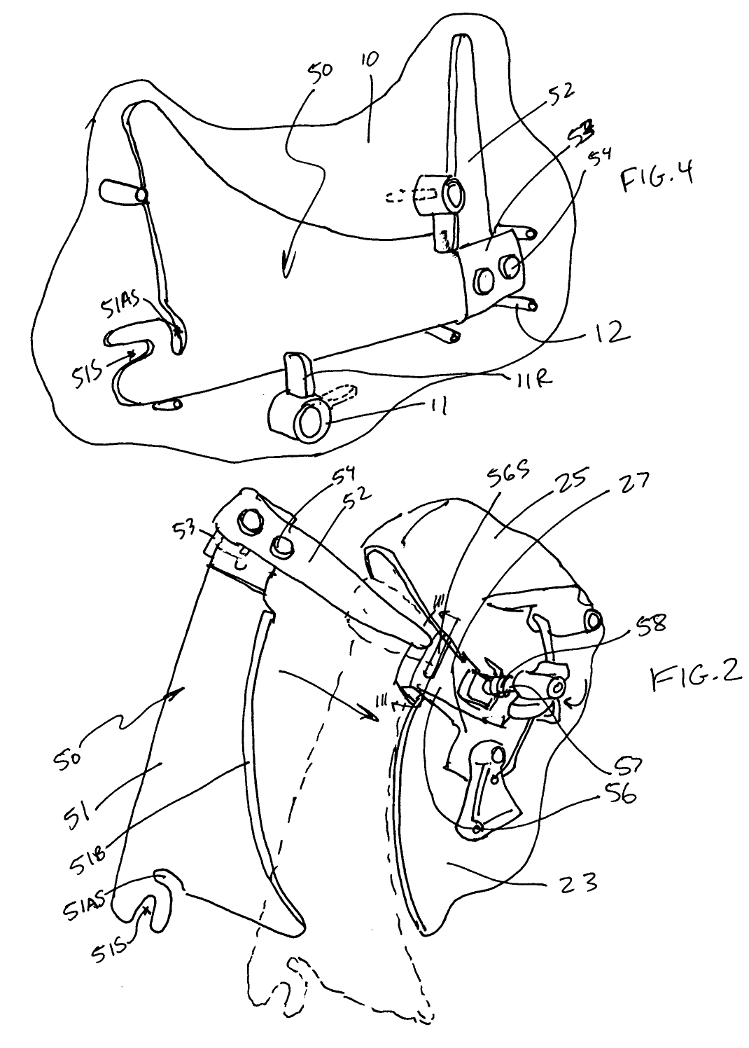

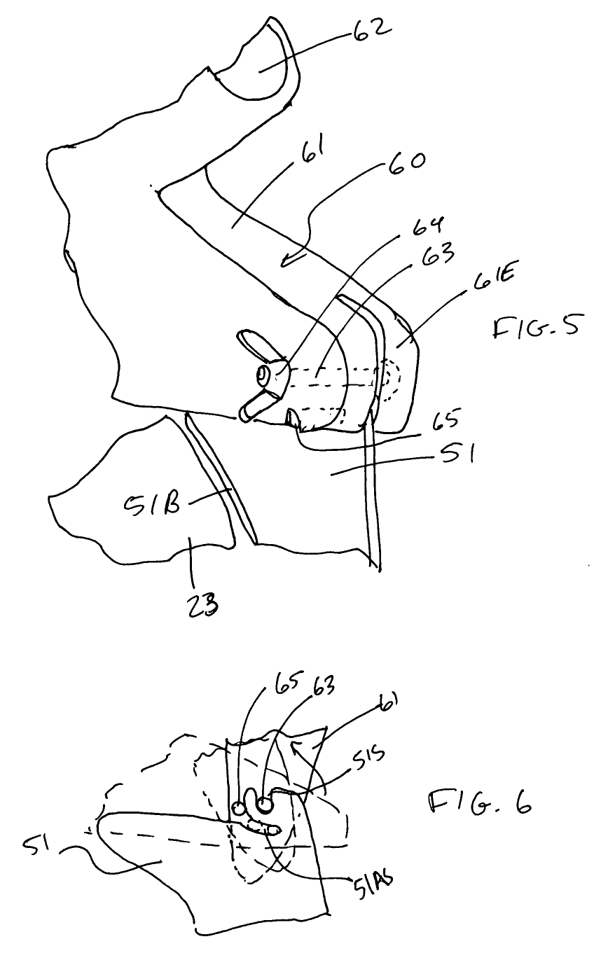

Referring to FIGS. 2-5, riving knife assembly 50 comprises a main body 51, with a curved blade edge 51B which will be placed adjacent to blade 23.

A bracket 52 is connected to main body 51. Bracket 52 can be inserted into a slot of support assembly 56. A thumbscrew 57 is threadingly engaged to support assembly 56. With such construction, a user would lift lower blade guard 25, allowing the user to insert bracket 52 into the slot 56S. The user can then lock the bracket 52 (and thus riving knife assembly 50) in place by rotating thumbscrew 57, which pushes bracket 52 into locking contact with support assembly 56 and/or upper blade guard 27.

A spring 58 may be disposed between the knob of thumbscrew 57 and support assembly 56. Spring 58 preferably prevents thumbscrew 57 from unscrewing due to vibration, such as when riving knife is not in place.

Preferably support assembly 56 has upper and lower walls 59, which form a tapered joint with bracket 52. The mating surfaces of bracket 52 and walls 59 may also be beveled, creating a dovetail junction as well. Such tapered junction will automatically locate the riving knife assembly 50 along the vertical and horizontal axes.

The area between walls 59 (of support assembly 56 and/or upper blade guard 27) is preferably machined. When thumbscrew 57 is tightened, the bracket 52 is pushed into such machined area along a third axis. Such arrangement preferably ensures that the riving knife assembly 50 is disposed in the same position every time it is installed unto saw 100, thus eliminating the need for readjustment.

Persons skilled in the art will recognize that it is desirable to place blade edge 51B relatively near blade 23. Accordingly, it is preferable to make blade edge 51B adjustable relative to bracket 52 so that, when bracket 52 is inserted into support assembly 56, blade edge 51B is in the desired position. Persons skilled in the art will recognize that body 51 can be connected to bracket 52 via screws 54, and that adjustability can be provided by providing slots on body 51 and/or bracket 52 so that screws 54 can move along such slots.

Alternatively, a plate 53 can be sandwiched between body 51 and bracket 52. Adjustability can be provided by providing slots on body 51, bracket 52 and/or plate 53, so that screws 54 can move along such slots. Preferably, body 51 can move relative to bracket 52 along axes A and/or B. Preferably, slots are provided in body 51 and bracket 52. Screws 54 go into plate 53 through said slots. Said slots are preferably perpendicular to each other and thus provide independent adjustment in their respective axes.

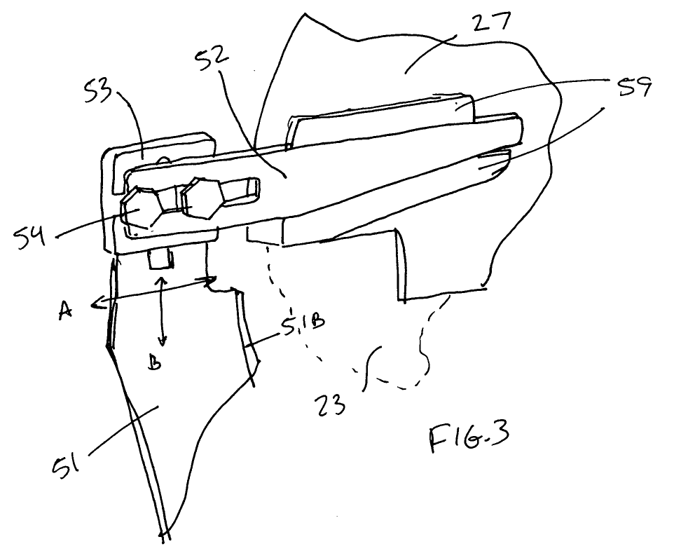

It is preferable to provide a place to store riving knife assembly 50. Referring to FIGS. 1 and 4, base assembly 10 may have bosses 12 to receive riving knife assembly 50 thereon. Rotatable retainers 11 with protrusions 11R may be pivotally attached to base assembly 10. Preferably, a retainer 11 can be moved between a first position where protrusion 11R overlaps riving knife assembly 50 (as shown in solid lines in FIG. 4), thus holding it in place, and a second position where protrusion 11R does not overlap riving knife assembly 50 (as shown in broken lines in FIG. 4), thus allowing a user to remove riving knife assembly 50 from base assembly 10.

Persons skilled in the art will recognize that that other means of retaining the riving knife assembly 50 in place, such as spring clips or magnets, could be substituted for retainer 11 and are considered to be equivalents of the present invention.

Persons skilled in the art will recognize that it may be advantageous to provide a blade guard assembly 60 that can be installed unto riving knife assembly 50. Referring to FIGS. 1 and 5-6, blade guard assembly 60 comprises a body 61, which is preferably substantially hollow, with a dust exhaust 62 connectable to a vacuum hose for extracting dust and chips generated during the cutting operation.

Body 61 may have two split portions 61E at one end thereof for receiving body 51 of riving knife assembly 50. A bolt 63 extends through both split portions 61E. A thumbscrew 64 may be provided at the end of the bolt 63 for sandwiching the portion of body 51 inserted between split portions 61E. Body 61 may also have a boss 65 disposed underneath bolt 63.

Preferably body 51 of riving knife assembly 50 has a substantially perpendicular slot 51S and an arcuate slot 51AS disposed adjacent to slot 51S. Persons skilled in the art will recognize that bolt 63 and boss 65 are preferably received by slots 51S, 51AS, respectively. Accordingly, it is desirable to ensure that the distance between slots 51S and 51AS are substantially similar to the distance between bolt 63 and boss 65.

Preferably, boss 65 has a screw that goes through the boss 65 and threadingly engages a hole in the body 61 on the opposite side. This increases the strength of boss 65.

With such arrangement, the user would insert bolt 63 into slot 51S (thus disposing body 61 unto body 51). Boss 65 would be automatically disposed in or near arcuate slot 51AS. The user would then rotate body 61 about bolt 63 so that boss 65 moves along arcuate slot 51AS, until a desired position is reached or boss 65 contacts the end of arcuate slot 51AS. The user can then lock blade guard assembly 60 by rotating thumbscrew 64.

Persons skilled in the art may recognize other additions or alternatives to the means disclosed herein. However, all these additions and/or alterations are considered to be equivalents of the present invention.

We claim:

1. A power tool comprising:
a base assembly;
a table supported by the base assembly;
a saw assembly supported by the table, the saw assembly comprising a motor, a blade driven by the motor, and an upper blade guard covering an upper part of the blade; and
a riving knife assembly attached to the saw assembly, the riving knife assembly comprising a body having an edge placed adjacent to the blade, and a bracket connected to the body;
wherein the bracket is inserted into a support assembly disposed on the upper blade guard.

2. The power tool of claim 1, further comprising a guard attached to the body of the riving knife assembly.

3. The power tool of claim 2, wherein the guard is pivotably attached to the body.

4. The power tool of claim 1, further comprising a screw extending through the support assembly.

5. The power tool of claim 4, further comprising a spring disposed between the screw and the support assembly.

6. The power tool of claim 1, wherein the support assembly has walls forming a taper.

7. The power tool of claim 6, wherein the taper engages the bracket.

8. The power tool of claim 1, wherein the saw assembly is pivotably attached to the table via a trunnion.

9. The power tool of claim 1, wherein position of the body is adjustable relative to the bracket.
